(19) United States
(12) Patent Application Publication
(10) Pub. No.: US 2006/0099838 A1
(43) Pub. Date: May 11, 2006

(54) Locking pins

(76) Inventor: Thomas Anthony Meyers, Mackay (AU)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 11/267,554

(22) Filed: Nov. 4, 2005

(30) Foreign Application Priority Data
Nov. 5, 2004 (AU) 2004906358
Nov. 19, 2004 (AU) 2004906618

(51) Int. Cl. H01R 13/44

(52) U.S. Cl. 439/134

(57) ABSTRACT

A releasably engageable locking pin for coupling members such as shackles and the like comprises a shaft of non-circular cross-section with a head at one end. The non-circular shaft is engageable in aligned complementary apertures in shackle devises to prevent rotation of the pin in the apertures. At the end of the pin opposite the head is a bayonet-type coupling formation to releasably engage a retaining member under the influence of a resilient bias caused by axial compression of a resiliently deformable member when in a locked position.

### FIELD OF THE INVENTION

This invention is concerned with improvements in releasably connectable locking pins in coupling mechanisms.

The invention is concerned particularly, although not exclusively, in releasably connectable locking pins for shackles and the like in earthworking equipment.

### BACKGROUND OF THE INVENTION

Releasably engageable locking pins are employed in a variety of engineering applications and in relation to earthworking equipment. Such locking pins may be utilized in rigid interconnection of boom elements of dragline excavators, pivotal connection of a boom to a chassis or frame, shackle pins for chains and wire ropes, dragline rigging systems and the like.

In nearly all engineering applications and, in particular, in the field of earthworking equipment, it is necessary to secure a retaining pin with a positive lock mechanism so that it does not become detached during operation. At the same time, there is a requirement that such locking pins be quickly and easily disconnected when required for maintenance and repair purposes. Typically, a releasable locking pin comprises a shaft which engages in aligned apertures in spaced cheeks or devises associated with a coupling member such as a shackle and an enlarged head on one end of the pin engages on an outer surface of one of the cheeks or devises. The free end of the pin often extends outwardly from an outer surface of the opposite cheek or clevis and a locking or engaging mechanism may be secured to the free end of the pin to prevent its withdrawal from the spaced cheeks or devises of the coupling member.

U.S. Pat. No. 4,476,673 describes a simple shackle pin locking mechanism in the form of a resilient clip engageable between a shackle clevis and an enlarged pin head formed in the shape of an annulus with a central aperture, the central axis of which apertures lies in a plane at right angles to a rotational axis of the pin. This clip locking mechanism is considered to be unsuitable in an earthworking environment due to the ease of dislodgement of the locking clip.

Other more complicated pin locking mechanisms are described in U.S. Pat. Nos. 5,433,547, 4,914,903, 4,221,252, 3,811,270, 2,214,912, and Re. 34046 which required deformable keeper mechanisms or resiliently biased keepers.

U.S. Pat. No. 5,597,260 describes a locking pin with radially extending projections on a free end thereof, the projections extending through a pair of flange plates having alignable apertures complementary to the cross-sectional shape of the pin end with the radial projections. By axially misaligning the apertures of respective flange plates and then bolting the plates together, a secure locking mechanism is effected.

U.S. Pat. No. 4,337,614 describes a similar system to that of U.S. Pat. No. 5,597,260 with a single apertured plate secured against rotation by a pin anchored on an inner face of the plate by a snap ring mounted in a slot in a specially contoured face of the shackle clevis.

Generally speaking, most of the prior art pin locking assemblies are satisfactory for their intended purpose however, in the case of many of these systems, the ease of disengagement of a locking pin has been sacrificed in the interest of obtaining a positive locking mechanism. In other more complicated mechanisms, the specially fabricated components, machined surfaces and the like have given rise to very expensive shackle/pin combinations unsuited to interchangeability of components.

Another serious disadvantage associated with prior art shackle pin retention systems is that the engagement mechanism which prevents relative rotation between, say, a threaded shaft and a nut or a cotter pin or a deformable keeper, is exposed to ingress of fine particles of earth which tightly pack around the retention mechanism to resist pin removal. Many such systems then require removal with a large hammer or the like to dislodge the compacted soil and otherwise to free the retaining mechanism. The use of impact devices such as hammers or the like in a field situation is considered dangerous due to the risk of injury from high velocity metal fragments which can break off during impact, or the risk of injury from a misdirected or glancing blow of the hammer.

Accordingly, it is an aim of the present invention to overcome or ameliorate one or more of the disadvantages associated with prior art pin locking systems and otherwise to provide consumers with a greater choice of pin locking systems.

### SUMMARY OF THE INVENTION

According to one aspect of the invention there is provided a locking pin system for a coupling member, said system comprising:—

a shaft member having a head formation adjacent one end of said shaft member;

a retaining member releasably engageable with a free end of said shaft member by a bayonet type coupling having at least one radially extending projection engageable in a shaped slot; and,

a resiliently deformable member, in use, to urge said shaft member and said retaining member into a locked engagement.

If required, said shaft member may be adapted to resist rotation in spaced locating apertures of said coupling member.

Suitably, said shaft member comprises a non-circular cross-sectional shape slidably engageable, in use, with aligned apertures of complementary shape in said locating apertures.

The shaft member may include at least one longitudinally extending planar surface.

Alternatively, said shaft member may be adapted to resist rotation in spaced locating apertures of a coupling member by engagement between an abutment on said head formation and an abutment on said coupling member.

Suitably, said at least one projection of said bayonet-type coupling is formed on an inner surface of said retaining member, said at least one projection being engageable with a shaped slot formed adjacent a free end of said shaft member.

Alternatively, said at least one projection may be formed on an outer surface of said shaft member adjacent a free end thereof, said at least one projection being engageable with a shaped slot formed in said retaining member.

If required, said retaining member is adapted for engagement by a torque inducing tool for imparting at least partial rotation relative to said shaft member.

The resiliently deformable member, in use, may be engageable between said retaining member and an adjacent outer surface of said coupling member whereby said retaining member is urged in an axial direction into releasable locking engagement with said shaft member.

Suitably, said resiliently deformable member includes an aperture through which said shaft member is insertable.

If required, a bearing member may be locatable, in use, between said retaining member and said resiliently deformable member to distribute into said resiliently deformable member a compressive force applied thereto by said retaining member.

If required, said at least one shaped slot may be contoured to provide a first cam surface, in use, effective to apply a compressive force to said resiliently deformable member when said retaining member is rotated between an unlocked position to a locked position.

Said at least one shaped slot may include a second cam surface, in use, effective to apply a compressive force to said resiliently deformable member to initially resist rotation of said retaining member between a locked and unlocked position.

The retaining member may comprise a socket engaging spigot for said torque inducing tool.

Alternatively, said retaining member may comprise a spigot engaging socket for said torque inducing tool.

According to another aspect of the invention there is provided a coupling member comprising a locking pin system as described herein.

### BRIEF DESCRIPTION OF THE DRAWINGS

In order that the invention may be more readily understood and put into practical effect, reference will now be made to embodiments illustrated in the accompanying drawings in which:—

FIG. 1 shows an exploded view of a locking pin assembly;

FIG. 2 shows a cross-sectional view through the retaining member of FIG. 1;

FIG. 3 shows an inverted isometric view of the retaining member of FIG. 1;

FIG. 4 shows a side elevational view of the shaft member of FIG. 1;

FIG. 5 shows an end elevational view of the shaft member of FIG. 1;

FIG. 6 shows schematically a part cross-sectional view of the locking pin assembly of FIG. 1 mounted in the devises of a shackle;

FIG. 7 shows a partial cross-sectional view of an alternative embodiment to the assembly of FIG. 6;

FIG. 8 shows an exploded view of an alternative embodiment to the assembly of FIG. 1; and

FIG. 9 shows a cross-sectional view through the retaining member of FIG. 8.

Like reference numerals have been employed for like features in the drawings for the sake of simplicity.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

### DETAILED DESCRIPTION OF THE DRAWINGS

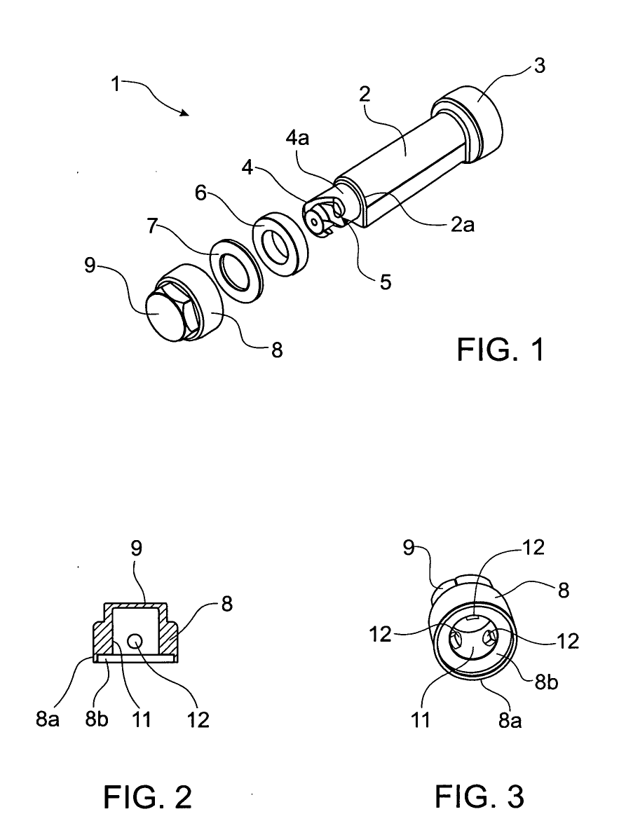

In FIG. 1, the locking pin system 1 comprises a shaft member 2 having an enlarged head 3 on one end thereof. Head 3 is generally circular in cross-section whereas shaft member 2 has a generally “D”-shaped cross-section as shown in FIG. 5.

On the free end of shaft member 2 is a generally cylindrical spigot 4 having formed therein circumferentially spaced slots 5 in the form of an inverted “j” shape.

A resiliently deformable member 6 comprising an apertured disk of weather resistant neoprene rubber, polyurethane, silicone or other suitable polymeric material is locatable on an unslotted land portion 4a of spigot 4. An annular steel washer 7 is locatable over spigot 4 and forms a bearing member to distribute compressive forces applied by the retaining member 8 to resiliently deformable member 6 and otherwise protects member 6 against tearing or damage as retaining member 8 rotates with member 6 under compression. Retaining member 8 includes a hex headed cap 9, the purpose of which will be described later.

FIG. 2 shows a cross-sectional view of retaining member 8 of FIG. 1.

In FIG. 2, retaining member 8 is formed with a hollow central recess 10 having a generally cylindrical inner wall 11 from which pins 12 project radially inwardly. A circumferential skirt 8a forms a locating recess 8b for steel washer 7.

An inverted isometric view of retaining member 8 is shown in FIG. 3 wherein it can be seen that there are three equidistantly spaced pins 12.

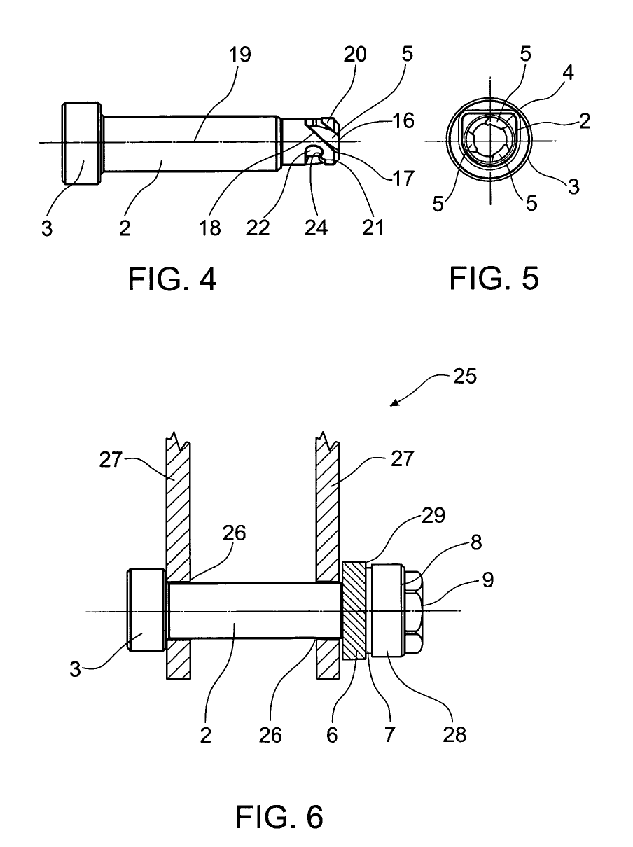

FIG. 4 shows a side elevational view of the shaft member of FIG. 1 in which the configuration of slots 5 is more clearly shown.

The mouth or opening 16 of each slot 5 is located at the free end 17 of shaft member 2 and the “leg” portion 18 of each “j” shaped slot is inclined relative to a longitudinal axis 19 of shaft member 2 such that when a pin 12 is located therein and a retaining member is rotated clockwise relative to shaft member 2, an inner edge 20 of slot 5 acts as a cam to move the retaining member in the direction of enlarged head portion 3 against a restoring force applied by resilient member 6 as shown in FIG. 1. With continued rotation, pins 12 move over respective cam surfaces 20 until they reach respective zeniths 21 on the cam surfaces 20 and the pins ride over zeniths 21 to locate in the blind ends 22 of slots 5 in the manner of a bayonet-type fitting. Pins 12 are urged into the undercut region 23 of blind ends 22 under a restoring influence applied by compressed resilient member 6.

In order to disengage retaining member 8 from shaft member 2, a hex socket of appropriate size is coupled to a socket bar and retaining member 8 is rotated anticlockwise. During rotation, inner edges 24 of blind ends 22 of slots 5 also act as cam surfaces on respective pins 12 of retaining member 8 to urge retaining member 8 into compression against resilient member 6 while pins 12 move over zeniths 21 and thence into respective leg portions 18 of slots 5.

FIG. 5 is an end elevational view of the shaft member 2 of FIG. 4.

In this illustration, the configuration of the three slots 5 can be more clearly seen and also the D-shaped cross-section of shaft member 2. The D-shaped cross-section of shaft member 2 is locatable in aligned apertures of spaced cheek plates or devises of a coupling member such as a shackle whereby rotation of shaft member 2 is presented during connection or disconnection of a retaining member thereto.

FIG. 6 shows a partial cross-sectional view of a coupling member 25 incorporating a locking pin assembly 1. Shaft member 2 extends via apertures 26 of complementary cross-sectional shape in the spaced devises 27 of a shackle or the like 25.

As can be seen in FIG. 6, when retaining member 8 is connected to shaft member 2, resilient member 6 is in compression due to the bayonet-type coupling therebetween.

With resilient member 6 in a compressed state, an effective soil and moisture proof seal is formed about the bayonet type coupling by engagement between the free end of side wall 28 of retaining member 8 (and/or washer 7) and an outer face 29 of resilient member 6. Similarly, an inner wall (not shown) of generally annular resilient member 6 is compressed against land portion 4a (shown in FIG. 1) of spigot 4 formed on the end of shaft member 2.

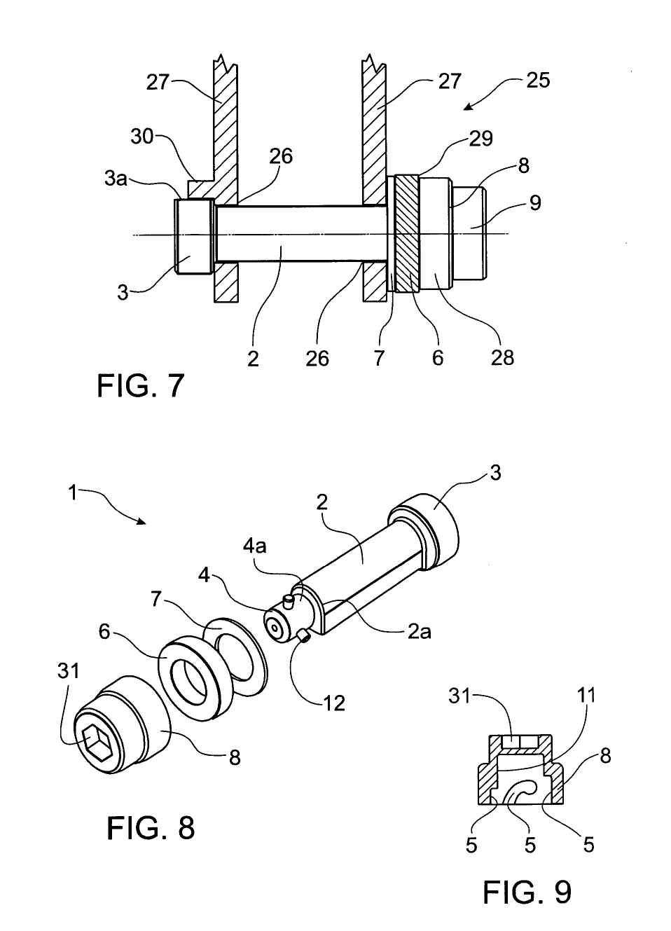

As illustrated in FIG. 7, in an alternative embodiment to that shown in FIG. 1, washer 7 may be located over land 4 on shaft member 2 to abut shoulder 2a thereon. Resilient seal member 6 is then sandwiched between washer 7 and the inner face 8b of retaining member 8 when the retaining member 8 is engaged in a coupling such as a shackle or the like. Washer 7 thus provides an increased bearing face against which resilient seal member 6 is compressible.

Also shown in FIG. 7 is an alternative mechanism to prevent shaft 2 from rotation within the aligned apertures 26 in the devises 27 of shackle or the like 28. In this embodiment, head 3 includes a flat or like abutment surface 3a which engages against a shouldered abutment 30 on clevis 27 to prevent relative rotation between shaft 2 and shackle or the like 28.

FIG. 8 illustrates an alternative configuration of locking pin assembly to that shown in FIG. 1.

In FIG. 8, the end of shaft 2 is formed with a cylindrical spigot 4 from which are circumferentially spaced radially extending pins 12. Retaining member 8 includes a hexagonal socket recess 31 to locate an Allan key or similar hexagonal driving spigot for rotation of retaining member 8.

FIG. 9 shows a cross-sectional view through the retaining member 8 of FIG. 8.

In FIG. 9, the inner wall surface 11 of retaining member 8 is formed with shaped slots 5 in the form of inverted “j” shape spaced circumferentially around inner wall surface 11. Like the arrangement of FIG. 1, the pins 12 and slots 5 form a spigot and socket bayonet-type coupling.

In use it has been found that locking pin assemblies according to the invention are robust and capable of withstanding harsh treatment in earthworking environments such as excavator rigging shackles. In particular, even after prolonged use, the locking pin assemblies are easily connected and disconnected with a conventional socket and torque bar by a single operator as the bayonet type coupling is sealed against the ingress of soil and moisture which otherwise tends to “freeze up” conventional locking pin assemblies. This ease of connection and disconnection obviates the need for the use of a hammer which otherwise would be required with many prior art shackle pins and thereby reduces the safety risks associated with such systems.

It readily will be apparent to a person skilled in the art that many modifications and variations may be made to the invention without departing from the spirit and scope thereof.

For example, although the embodiment illustrated comprises a bayonet-type coupling having three pins locatable in respective slots, it is considered that one or more pin/slot combinations would be effective, however two or more pin/slot combinations would provide a more even load distribution between the components of the bayonet-type coupling.

Similarly, while the embodiment illustrated shows pin slots formed on shaft member 2 and pins located in retaining member 8, the pins of the bayonet-type coupling could be formed on shaft member 2 for releasable engagement with corresponding slots formed in retaining member 8.

1. A locking pin system for a coupling member, said system comprising:—
a shaft member having a head formation adjacent one end of said shaft member;
a retaining member releasably engageable with a free end of said shaft member by a bayonet type coupling having at least one radially extending projection engageable in a shaped slot; and,
a resiliently deformable member, in use, to urge said shaft member and said retaining member into a locked engagement.

2. A system as claimed in claim 1 wherein said shaft member is adapted to resist rotation in spaced locating apertures of said coupling member.

3. A system as claimed in claim 2 wherein said shaft member comprises a non-circular cross-sectional shape slidably engageable, in use, with aligned apertures of complementary shape in said locating apertures.

4. A system as claimed in claim 3 wherein said shaft member includes at least one longitudinally extending planar surface.

5. A system as claimed in claim 2 wherein said shaft member is adapted to resist rotation in spaced locating apertures of a coupling member by engagement between an abutment on said head formation and an abutment on said coupling member.

6. A system as claimed in claim 1 wherein said at least one projection of said bayonet-type coupling is formed on an inner surface of said retaining member, said at least one projection being engageable with a shaped slot formed adjacent a free end of said shaft member.

7. A system as claimed in claim 1 wherein said at least one projection is formed on an outer surface of said shaft member adjacent a free end thereof, said at least one projection being engageable with a shaped slot formed in said retaining member.

8. A system as claimed in claim 1 wherein said retaining member is adapted for engagement by a torque inducing tool for imparting at least partial rotation relative to said shaft member.

9. A system as claimed in claim 1 wherein said resiliently deformable member, in use, is engageable between said retaining member and an adjacent outer surface of said coupling member whereby said retaining member is urged in an axial direction into releasable locking engagement with said shaft member.

10. A system as claimed in claim 1 wherein said resiliently deformable member includes an aperture through which said shaft member is insertable.

11. A system as claimed in claim 1 wherein a bearing member is locatable, in use, between said retaining member and said resiliently deformable member to distribute into said resiliently deformable member a compressive force applied thereto by said retaining member.

12. A system as claimed in claim 1 wherein a bearing member is locatable, in use, between said coupling member and said resiliently deformable member to distribute, at least partially, into said resiliently deformable member a compressive force applied by said retaining member.

13. A system as claimed in claim 1 wherein said at least one shaped slot is contoured to provide a first cam surface, in use, effective to apply a compressive force to said resiliently deformable member when said retaining member is rotated between an unlocked position to a locked position.

14. A system as claimed in claim 13 wherein said at least one shaped slot includes a second cam surface, in use, effective to apply a compressive force to said resiliently deformable member to initially resist rotation of said retaining member between a locked and unlocked position.

15. A system as claimed in claim 8 wherein said retaining member comprises a socket engaging spigot for said torque inducing tool.

16. A system as claimed in claim 8 wherein said retaining member comprises a spigot engaging socket for said torque inducing tool.
